(19) United States
(12) Patent Application Publication
(10) Pub. No.: US 2026/0352479 A1
(43) Pub. Date: Nov. 5, 2026

(54) METHOD AND SYSTEM FOR AUTHENTICATION OF A USER

(71) Applicant: Zeroth Technology Inc, Hillsborough, NJ (US)

(72) Inventors: James Charles Canterbury, Hillsborough, NJ (US); Ankur Garg, Chandler, AZ (US)

(21) Appl. No.: 19/389,114

(22) Filed: Nov. 14, 2025

Related U.S. Application Data
(60) Provisional application No. 63/707,835, filed on Oct. 16, 2024.
(60) Provisional application No. 63/797,140, filed on Apr. 30, 2025.
(60) Provisional application No. 63/807,583, filed on May 17, 2025.

(30) Foreign Application Priority Data
Nov. 4, 2024 (AU) 2024903590

(51) Int. Cl. H04L 9/32; G06V 10/44; G06V 40/50; H04L 9/08

(52) U.S. Cl. CPC H04L 9/3231; G06V 10/454; G06V 40/50; H04L 9/0866

(57) ABSTRACT

A method for authentication of a user is disclosed. The method includes receiving a unique session key for a session. The method includes generating an optical signal sequence based on unique session key to obtain a depth-encoded capture of at least one facial region of a user. The method includes generating a depth-encoded facial vector corresponding to user based on the depth-encoded capture. The method includes transmitting depth-encoded facial vector corresponding to user to one or more authentication devices. Each of one or more authentication devices is configured to contemporaneously receive a surface capture of a video feed corresponding to session from one of user device or a second user device; generate a surface facial vector corresponding to user based on the surface capture of the video feed; and compare depth-encoded facial vector with surface facial vector based on a similarity analysis to authenticate user.

### TECHNICAL FIELD

This disclosure relates generally to authentication software, and more particularly to a method and system for authentication of a user.

### BACKGROUND

The proliferation of digital communication platforms has been accompanied by a significant rise in sophisticated identity fraud. Malicious actors are increasingly leveraging Artificial Intelligence (AI) to create synthetic media (such as deepfakes and real time filters), which makes it increasingly difficult to distinguish genuine individuals from synthetic representation during live digital interactions.

In present state of art, techniques for verifying users during live digital interactions (such as, deepfake detection algorithms, proof-of-human protocols, digital provenance systems, centralized identity providers, biometric based authentication systems, and the like) exist. However, the existing biometric-based authentication techniques may rely on centralized biometric templates (such as face ID enrollment, server-side faceprints, or the like). These stored templates may represent significant vulnerabilities. They are susceptible to breaches, spoofing, replay attacks, and offer a stable target for adversaries. Further, when templates are centrally stored, facial scans consequently depend on the server or device holding the localized faceprint, and typically on that same entity for subsequent real time matching. Therefore, there is a critical need for an advanced technique which require only one-time biometric verification instead of matching against a stored faceprint.

The present invention is directed to overcome one or more limitations stated above or any other limitations associated with the known arts.

### SUMMARY

In one embodiment, a method for authentication of a user is disclosed. In one example, the method may include receiving a unique session key for a session. The method may further include generating an optical signal sequence based on the unique session key to obtain a depth-encoded capture of at least one facial region of a user. It should be noted that the depth-encoded capture may include the optical signal sequence projected upon the at least one facial region of the user. The method may further include generating a depth-encoded facial vector corresponding to the user based on the depth-encoded capture. It should be noted that the depth-encoded facial vector may include a set of first facial features and a set of first optical signal sequence features. The method may further include transmitting the depth-encoded facial vector corresponding to the user to one or more authentication devices. Each of the one or more authentication devices is configured to contemporaneously receive a surface capture of a video feed corresponding to the session from one of the user device or a second user device. Each of the one or more authentication devices is also configured to generate a surface facial vector corresponding to the user based on the surface capture. It should be noted that the surface facial vector may include a set of second facial features and a set of second optical sequence features. Each of the one or more authentication devices is also configured to compare the depth-encoded facial vector with the surface facial vector based on a similarity analysis to authenticate the user.

In another embodiment, a method for authentication of a user is disclosed. In one example, the method may include receiving a unique session key for a session. The method may further include receiving a depth-encoded facial vector corresponding to a user from a user device. The user device is configured to generate an optical signal sequence based on the unique session key to obtain a depth-encoded capture of at least one facial region of the user. It should be noted that the depth-encoded capture may include the optical signal sequence projected upon the at least one facial region of the user. The user device is also configured to generate the depth-encoded facial vector corresponding to the user based on the depth-encoded capture. It should be noted that the depth-encode facial vector may include a set of first facial features and a set of first optical signal sequence features. The user device is also configured to transmit the depth-encoded facial vector corresponding to the user to the authenticating device. The method may further include contemporaneously receiving a surface capture of a video feed corresponding to the session from one of the user device or a second user device. The method may further include generating a surface facial vector corresponding to the user based on the surface capture of the video feed. It should be noted that the surface facial vector may include a set of second facial features and a set of second optical signal sequence features. The method may further include comparing the depth-encoded facial vector with the surface facial vector based on a similarity analysis to authenticate the user.

In yet another embodiment, a system for authentication of a user is disclosed. In one example, the system may include a processor and a computer-readable medium communicatively coupled to the processor. The computer-readable medium may store processor-executable instructions, which, on execution, may cause the processor to receive a unique session key for a session. The processor-executable instructions, on execution, may further cause the processor to generate an optical signal sequence based on the unique session key to obtain a depth-encoded capture of at least one facial region of a user. It should be noted that the depth-encoded capture may include the optical signal sequence projected upon the at least one facial region of the user. The processor-executable instructions, on execution, may further cause the processor to generate a depth-encoded facial vector corresponding to the user based on the depth-encoded capture. It should be noted that the depth-encoded facial vector may include a set of first facial features and a set of first optical signal sequence features. The processor-executable instructions, on execution, may further cause the processor to transmit the depth-encoded facial vector corresponding to the user to one or more authentication devices. Each of the one or more authentication devices is configured to contemporaneously receive a surface capture of a video feed corresponding to the session from one of the user device or a second user device. Each of the one or more authentication devices is also configured to generate a surface facial vector corresponding to the user based on the surface capture of the video feed. It should be noted that the surface facial vector may include a set of second facial features and a set of second optical signal sequence features. Each of the one or more authentication devices is also configured to compare the depth-encoded facial vector with the surface facial vector based on a similarity analysis to authenticate the user.

In yet another embodiment, a system for authentication of a user is disclosed. In one example, the system may include a processor and a computer-readable medium communicatively coupled to the processor. The computer-readable medium may store processor-executable instructions, which, on execution, may cause the processor to receive a unique session key for a session. The processor-executable instructions, on execution, may further cause the processor to receive a depth-encoded facial vector corresponding to a user from a user device. The user device is configured to generate an optical signal sequence based on the unique session key to obtain a depth-encoded capture of at least one facial region of the user. It should be noted that the depth-encoded capture may include the optical signal sequence projected upon the at least one facial region of the user. The user device is also configured to generate the depth-encoded facial vector corresponding to the user based on the depth-encoded capture. It should be noted that the depth-encoded facial vector may include a set of first facial features and a set of first optical signal sequence features. The user device is also configured to transmit the depth-encoded facial vector corresponding to the user to the authenticating device. The processor-executable instructions, on execution, may further cause the processor to contemporaneously receive a surface capture of a video feed corresponding to the session from one of the user device or a second user device. The processor-executable instructions, on execution, may further cause the processor to generate a surface facial vector corresponding to the user based on the surface capture of the video feed. It should be noted that the surface facial vector may include a set of second facial features and a set of second optical signal sequence features. The processor-executable instructions, on execution, may further cause the processor to compare the depth-encoded facial vector with the surface facial vector based on a similarity analysis to authenticate the user.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates a functional block diagram of a system for authentication of a user, in accordance with some embodiments of the present disclosure.

FIGS. 2A and 2B illustrate a flow diagram of an exemplary process for authentication of a user, in accordance with some embodiments of the present disclosure.

FIG. 3 illustrates a generation of a depth-encoded capture of facial regions, in accordance with some embodiments of the present disclosure.

FIGS. 4A and 4B illustrate communication flow diagrams between a user device and an authentication device for authentication of a user, in accordance with some embodiments of the present disclosure.

FIG. 5 illustrates a flow diagram of a detailed exemplary control logic for training a blink decoder for reconstructing session key representations from depth-encoded vectors, in accordance with some embodiments of the present disclosure.

FIG. 6 illustrates a flow diagram for a comparison of a depth-encoded facial vector with a surface facial vector, in accordance with some embodiments of the present disclosure.

FIGS. 7A, 7B, and 7C illustrate exemplary scenarios for authenticator-initiated user authentication, in accordance with some embodiments of the present disclosure.

FIGS. 8A and 8B illustrate exemplary scenarios for user-initiated self-authentication, in accordance with some embodiments of the present disclosure.

FIG. 9 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

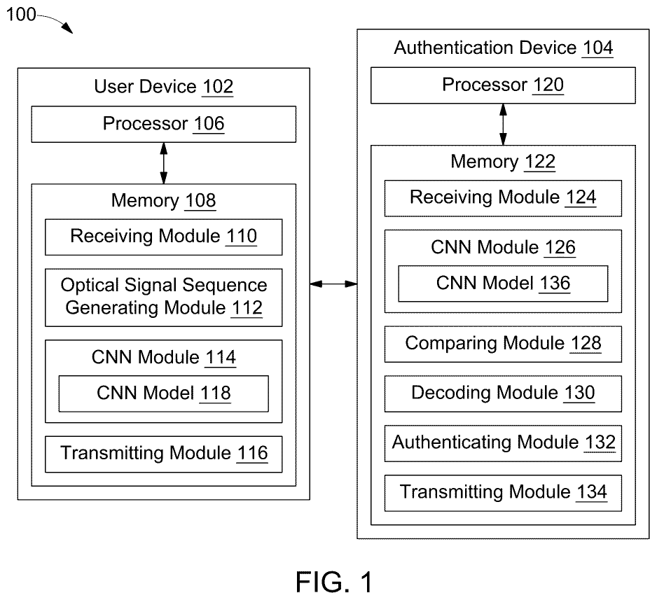

Referring now to FIG. 1, a functional block diagram of a system 100 for authentication of a user is illustrated, in accordance with some embodiments of the present disclosure. The system 100 may be implemented over a video interaction session between a user and one or more authenticators. The one or more authenticators (or “verifiers”) may be individuals that may seek to confirm an identity (or authenticity) of the user (or “presenter”). The user may be an individual that may, in turn, seek to confirm their identity (or authenticity) to the one or more authenticators. In other words, the one or more authenticators may require a confirmation that a video feed received from the user in the video session is not an Artificial Intelligence (AI) generated video feed. Additionally, the one or more authenticators may require proof that the person in the video feed is actually the user.

The system 100 may include a user device 102 operated by a user. The user device 102 may be communicatively coupled with an authentication device 104 operated by an authenticator through a communication network. It should be noted that one or more authentication devices may be in communication with the user device 102. In embodiments with multiple authentication devices, the steps performed for user authentication by each of the multiple authentication devices may be same as the steps performed by the authentication device 104. Thus, for ease of explanation, a single authentication device (i.e., the authentication device 104) is shown in figure. Each of the user device 102 and the authentication device 104 may be, for example, but may not be limited to, a smartphone, a tablet, a laptop, a desktop, or any other computing device, in accordance with some embodiments of the present disclosure.

In an embodiment, the video session between the user and the authenticator may be facilitated via the user device 102 and the authentication device 104. In some other embodiments, the video session may be facilitated via separate computing devices operated by the user and the authenticator. In other words, the user may join and interact during the video session through a user-operated computing device (which may be the user device 102 or a second user device). Similarly, the authenticator may join and interact during the video session through an authenticator-operated computing device (which may be the authentication device 104 or a second authentication device). During the video session, a video feed of the authenticator may be displayed on the user-operated computing device. Similarly, a video feed of the user may be displayed on the authenticator-operated computing device.

The user device 102 may include a processor 106 and a memory 108. The memory 108 may store instructions that, when executed by the processor 106, may cause the processor 106 to self-authenticate the user, in accordance with aspects of the present disclosure. The memory 108 may also store various data (for example, depth-encoded capture of at least one facial region of a user, a depth-encoded facial vector, a set of first facial features, a set of first optical signal sequence features, a set of facial features, or the like). The memory 108 may include a receiving module 110, an optical signal sequence generating module 112, a Convolutional Neural Network (CNN) module 114, and a transmitting module 116. The CNN module 114 may include a CNN model 118. For example, the CNN model 118 may be, but may not be limited to, LeNet, AlexNet, VGGNet, ResNet, GoogleNet, and the like.

The authentication device 104 may include a processor 120 and a memory 122. The memory 122 may store instructions that, when executed by the processor 120, may cause the processor 120 to authenticate the user, in accordance with aspects of the present disclosure. The memory 122 may also store various data (for example, the depth-encoded facial vector, a surface facial vector, a surface capture of a video feed, a set of second facial features, a predefined threshold similarity score, a predefined threshold fidelity score, or the like). The memory 122 may include a receiving module 124, a CNN module 126, a comparing module 128, a decoding module 130, an authenticating module 132, and a transmitting module 134. The CNN module 126 may include a CNN model 136. In an embodiment, the CNN model 136 may be analogous to the CNN model 118.

In an embodiment, the authentication of the user may be initiated by the user (i.e., presenter-initiated authentication) during the session. In another embodiment, the authentication of the user may be initiated by the authenticator (i.e., verifier-initiated authentication) during the session. The receiving module 110 of the user device 102 may receive a unique session key for a session. By way of an example, the unique session key may be in a format of a numeric value, an alphabetic value, alpha-numeric value, a machine-scannable code (such as a bar code, a QR code, etc.), or the like. For the presenter-initiated authentication, the receiving module 110 may generate the unique session key for the session based on a digital identity (ID) of a user. For example, the digital identity may be, but may not be limited to, e-signature, user ID, password, facial scan, fingerprint, or the like. Further, the receiving module 110 may transmit the unique session key to a server. For the verifier-initiated authentication, the transmitting module 134 may generate or derive the unique session key through a cryptographic key generation technique (for example, an Elliptic Curve Diffie-Hellman key exchange followed by a key derivation function that incorporates a nonce and a timestamp). Further, the transmitting module 134 may transmit the unique session key to the user device 102. The receiving module 110 of the user device 102 may receive the unique session key for the session from the transmitting module 134 of the authentication device 104.

Upon receiving the unique session key, the receiving module 110 may send the unique session key to the optical signal sequence generating module 112. Further, the optical signal sequence generating module 112 may generate an optical signal sequence based on the unique session key to obtain a depth-encoded capture of at least one facial region of the user. In other words, the optical signal sequence generating module 112 may convert the unique session key into a specific arrangement of light pulses. The optical signal sequence may be generated in a unique sequence of different colored light waves (such as blue, red, yellow, green, violet, or the like), or may be generated at a unique pulse rate (frequency) of a single colored light. In an embodiment, the optical signal sequence may be generated in a combination of light colors and frequency. In an embodiment, the optical signal sequence may be generated through a display of the user device 102. In another embodiment, the optical signal sequence may be generated through a flashlight of the user device 102. In an alternative embodiment, the optical signal sequence may be generated through programmable light sources (e.g., Light Emitting Diode (LED) arrays, projectors, etc.) in communication with the user device 102.

The depth encoded capture may be obtained from a camera and, optionally, a depth sensor of the user device 102. The user may project the optical signal sequence upon at least one facial region of the user. In some embodiments, the emission of the optical signal sequence may be paused when among the at least one facial region of the user, an ocular landmark (i.e., eye region) is detected to prevent user discomfort. Contemporaneously, the user may direct a Field of View (FoV) of the camera and the depth sensor towards the at least one facial region. The camera may then capture a video of the at least one facial region with the optical signal sequence projected thereupon. Additionally, the depth sensor may capture a depth map of the at least one facial region of the user. The video and the depth map may be combined to obtain the depth encoded capture.

Further, the CNN module 114 may receive the depth-encoded capture. The CNN module 114 may generate a depth-encoded facial vector corresponding to the user based on the depth-encoded capture using the CNN model 118. The “depth-encoded facial vector” is herein also referred to as a “high-fidelity vector”. The depth-encoded facial vector may include a set of first facial features (e.g., eyes, nose, mouth, forehead, or the like), a set of first optical signal sequence features (e.g., bits_per_symbol (1/2/3), palette_id, τ_ms, blend_ms, delimiter_scheme (delimited|delimiter-free), inter_key_delimiter, repeats (3-5), crc_bits, fec., or the like), and a set of geometrical features (i.e., depth features such as micro-texture, parallax, or other depth information). The depth-encoded facial vector may facilitate a peer-verifiable authentication that may be highly resistant to various attack (such as deep-fake impersonation, replay attacks, injection attacks, or the like) without necessitating the storage of persistent biometric templates (or reliance on centralized identity proofs).

To generate the depth-encoded facial vector, the CNN module 114 may extract the set of first facial features, the set of first optical signal sequence features, and the set of geometrical features from the depth-encoded capture using the CNN model 118. In some embodiments, the CNN module 114 may evaluate a depth corresponding to the at least one facial region of the user based on the set of geometrical features. The evaluation of the depth is one of the aspects of user authentication. Additionally, the CNN module 114 may encode, via the CNN model 118, the depth-encoded facial vector using the set of first facial features and the set of first optical signal sequence features. In other words, the depth-encoded facial vector may be obtained through an entanglement of the set of first facial features with the set of first optical signal sequence features. As will be explained later, the depth-encoded facial vector may enable user authentication based on depth validation, and comparisons of the depth-encoded facial vector with a surface facial vector and the unique session key.

In some embodiments, upon generating the depth-encoded facial vector, the CNN module 114 may transform the depth-encoded facial vector through a rotation operation based on the unique session key. This ensures that the unique session key is indispensable for aligning vectors, adding robustness against spoofing. Further, the CNN module 114 may send the depth-encoded facial vector to the transmitting module 116.

Further, the transmitting module 116 may transmit a bounded-use representation of the depth-encoded facial vector corresponding to the user to one or more authentication devices (such as the authentication device 104). The depth-encoded facial vector is at least partially obfuscated to obtain the bounded-use representation. It may be noted that the bounded-use representation cannot be reconstructed by a CNN model back into the depth-encoded facial vector independently. The bounded-use representation can only be validated in conjunction with the unique session key. In simpler words, the bounded-use representation is a partially locked the depth-encoded facial vector. A partially locked portion of the bounded-use representation may be unlocked in the authentication device 104 using the unique session key. In the presenter-initiated flow, the transmitting module 116 may store the bounded-use representation of the depth-encoded facial vector in the server. Then, each of the unique session key and the bounded-use representation is later retrievable by the one or more authentication devices.

Further, the receiving module 124 of the authentication device 104 may receive the bounded-use representation of the depth-encoded facial vector from the transmitting module 116 of the user device 102. Additionally, the receiving module 124 may contemporaneously receive a surface capture of the video feed corresponding to the session from one of the user device 102 or the second user device. In the verifier-initiated flow, the surface capture may be captured by the authentication device 104 from the second authentication device. Alternatively, in the verifier-initiated flow, the surface capture may be obtained by the authentication device 104 in form of a screen recording of the authentication device 104. In the presenter-initiated flow, the receiving module 124 may retrieve the unique session key for the session and the bounded-use representation of the depth-encoded facial vector corresponding to the user stored in the server by the user device 102.

Further, the receiving module 124 may send the surface capture of the video feed to the CNN module 126. Further, the CNN module 126 may generate a surface facial vector corresponding to the user based on the surface capture using the CNN model 136. The surface facial vector may include a set of second facial features and a set of second optical signal sequence features. Further, the CNN module 126 may send the surface facial vector to the comparing module 128.

The decoding module 130 may reconstruct the depth-encoded facial vector from the bounded-use representation using the unique session key. In embodiments where the depth-encoded facial vector is transformed by the rotation operation, the decoding module 130 may also reconstruct the depth-encoded facial vector through a de-rotation operation using the unique session key. Further, the decoding module 130 may generate a first reconstructed session key representation from the set of first optical signal sequence features of the depth-encoded facial vector using a decoding technique. Additionally, the decoding module 130 may generate a second reconstructed session key representation from the surface facial vector.

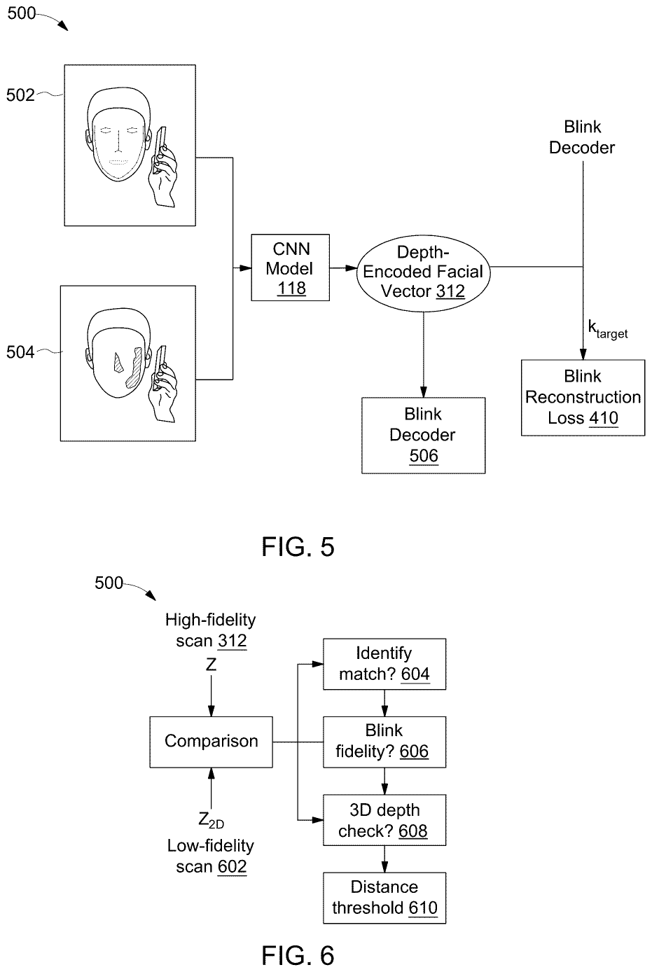

Further, the comparing module 128 may compare the depth-encoded facial vector with the surface facial vector based on a similarity analysis to authenticate the user. To authenticate the user, the comparing module 128 may compare the first reconstructed session key representation, the second reconstructed session key representation, and the unique session key (i.e., the originally generated unique session key). Further, comparing module 128 may compute a sequence fidelity score based on the comparison between the first reconstructed session key representation, the second reconstructed session key representation, and the unique session key. Further, the comparing module 128 may compare the sequence fidelity score with a predefined threshold fidelity score. The predefined threshold fidelity score may fall within the range of (0-1). This is further explained in greater detail in conjunction with FIG. 5. For example, the sequence fidelity score may be, but may not be limited to, a cosine similarity, a Euclidean distance, a Jaccard similarity, a Minkowski distance, or a Manhattan distance.

Additionally, the comparing module 128 may compare the set of first facial features with the set of second facial features based on the similarity analysis to obtain a facial feature similarity score. Further, the comparing module 128 may compare the facial feature similarity score with a predefined threshold similarity score. The predefined threshold similarity score may fall within the range of (0-1). This is further explained in greater detail in conjunction with FIG. 6.

Further, the authenticating module 132 may authenticate the user based on the facial feature similarity score and the sequence fidelity score. In particular, the authenticating module 132 may combine the similarity score and the fidelity score to generate a combined score. Further, the authenticating module 132 may compare the combined score with a predefined distance threshold score. For example, when the combined score is above the predefined distance threshold score, the user authentication may be successful. When the combined score is below the predefined distance threshold score, the user authentication may be unsuccessful. Advantageously, a robust user authentication is conducted, particularly due to the entropy of the unique session key, the temporal precision of the optical signal sequence, and the entanglement achieved by the CNN model. This is further explained in greater detail in conjunction with FIG. 6.

In some embodiments, the CNN model 118 and the CNN model 136 may be trained using labelled training data based on an identity loss, a sequence reconstruction loss, and a temporal loss. The identity loss is based CNN model-generated facial region vectors. The sequence reconstruction loss is based on CNN model-reconstructed session key. The temporal loss is based on timestamp-based alignment of facial features and optical signal sequence features. In an embodiment, the CNN model 118 and the CNN model 136 may be fine-tuned CNN models. In such an embodiment, the CNN model 118 and the CNN model 136 may be existing CNN models adapted to simultaneously detect facial features and optical signal sequence features from the depth-encoded capture.

The labelled training data may include data from pre-stored video sessions. The data may include synchronized user and authenticator video feed captures per session. Additionally, the pre-stored video sessions may incorporate a wide variety of session keys and optical signals (such as delimited and delimiter-free, 3-bit and 2-bit alphabets, terminator=white or red, blends on/off, repeats 3-5, etc.). The pre-stored video sessions may include video sessions in a wide range of environments (varying skin tones, indoor/outdoor, various phones/monitors (white-points/gammas), lighting levels, motion/occlusion, etc.). The labels in the labelled training data may correspond to person ID, blink parameters, symbol sequence (or weak labels), capture path (user vs authenticator). Additionally, the training data may be split into a train set and a test set (subject-disjoint train/val/test+a ‘nasty’ test set (worst-case light/motion)).

Initially, for a first training phase, the CNN model 118 and the CNN model 136 (collectively referred to as “CNN models”) are pretrained for identity separation (i.e., only for facial features, not for optical signal sequence features). Further, for a second training phase, the CNN models are further fine-tuned with blink supervision (both delimited and delimiter-free), cross-path pairing (user-authenticator), duration jitter, and offset search. For a third training phase, the CNN models are made device-ready (i.e., ready to be deployed). The CNN models undergo quantization-aware training to INT8 and are exported to device Machine Learning (ML) frameworks (such as Core ML, NNAPI, or TFLite).

In some embodiments, the user authentication may require an additional authentication check of Temporal Identity Proofs (TIPs) from the user. TIPs represent an optional, yet in some embodiments, integral component of the user authentication. TIPs are designed to significantly enhance the substantiation of an identity of the user and can be utilized, for example, in response to a request from the authenticator, to demonstrate that the user has control over a specific claimed identity attribute or credential (e.g., an online professional networking account). TIPs function as time-limited, context-specific aggregations of identity evidence. When a TIP is requested by an authenticator, the request mechanism may also serve as a means for the verifier to securely transmit their public cryptographic key to the user. This allows the user to encrypt the TIP before its transmission to the authenticator. Such encryption not only provides essential security for the TIP, which may contain personally identifiable information (PII), but also serves as a method for establishing a shared cryptographic secret between the authenticator and the user.

A TIP is composed by aggregating one or more trust anchors (i.e., recently expired authentication tokens from various accounts). These trust anchors can be selected by the user autonomously or in response to specific requirements stipulated by an authenticator, thereby demonstrating the control of the user over these trust anchors at the time of the TIP creation. In an embodiment, the one or more trust anchors are Javascript Web Tokens (JWTs) that capture the userID and Authentication timestamp. It should be noted that only expired tokens may be used to prevent the authenticator from using the token to access the user account. In an embodiment, emerging zk TLS (zero knowledge transport layer security) techniques may be used to also include certain data into the TIP (such as age verification) that can be selectively disclosed to the authenticator.

Furthermore, when a TIP is encrypted using public/private key pairs associated with both the authenticator and the user, a shared secret can be established. This shared secret may subsequently be used to derive session-specific cryptographic keys, providing assurance to both the user and the authenticator that the counterparty in the current interaction is indeed the same entity with whom the TIP was previously exchanged.

TIPs exhibit several key properties. TIPs are inherently temporal, meaning a TIP is typically valid only for a specific event, interaction, or a defined timeframe, rendering it unsuitable for use outside this intended context. TIPs support selective disclosure, whereby the user generally retains control over which trust anchors are included and revealed, although an authenticator may request the inclusion of specific anchors. They are designed to be privacy-preserving; for instance, a TIP can be encrypted for the intended authenticator, and certain types of trust anchors may lend themselves to the use of zero-knowledge proofs (ZKPs), which can prove specific attributes or claims without revealing the underlying sensitive data. Finally, TIPs are verifiable, as cryptographic signatures can be used to bind the aggregated trust anchors together, link them to the derived shared secret, and affirm their authenticity.

In an embodiment, instead of generating the optical signal sequence, the user device 102 may generate an audio signal sequence based on the unique session key. In other words, the user device 102 may encode the unique session key as the audio signal sequence. The user may record a video of the at least one facial region while playing the audio signal sequence to obtain an audio-encoded capture of the at least one facial region. The audio signal sequence may be in form of beeps, tones, chirps, or the like. Further, the CNN model 118 of the user device 102 may generate an audio-encoded facial vector of the user. The audio-encoded facial vector may include the audio signal sequence entangled with facial features of the at least one facial region. Further, the transmitting module 116 may send the audio-encoded facial vector to the receiving module 124 of the authentication device 104. Additionally, the authenticator may contemporaneously record surface audio/video (i.e., the audio/video feed) of the user playing the audio signal sequence to obtain the surface capture. The CNN model 136 may then extract both acoustic and visual features from the surface capture to obtain a surface facial vector. Further, the comparing module 136 may compare the surface facial vector with the decoded audio-encoded facial vector to authenticate the user.

It should be noted that all such aforementioned modules 110-116 and 124-134 may be represented as a single module or a combination of different modules. Further, as will be appreciated by those skilled in the art, each of the modules 110-116 and 124-134 may reside, in whole or in parts, on one device or multiple devices in communication with each other. In some embodiments, each of the modules 110-116 and 124-134 may be implemented as dedicated hardware circuit comprising custom application-specific integrated circuit (ASIC) or gate arrays, off-the-shelf semiconductors such as logic chips, transistors, or other discrete components. Each of the modules 110-116 and 124-134 may also be implemented in a programmable hardware device such as a field programmable gate array (FPGA), programmable array logic, programmable logic device, and so forth. Alternatively, each of the modules 110-116 and 124-134 may be implemented in software for execution by various types of processors (e.g., processors 106 and 120). An identified module of executable code may, for instance, include one or more physical or logical blocks of computer instructions, which may, for instance, be organized as an object, procedure, function, or other construct. Nevertheless, the executables of an identified module or component need not be physically located together but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for authentication of a user. For example, the user device 102 and the authentication device 104, may authenticate the user, by the processes discussed herein. In particular, as will be appreciated by those of ordinary skill in the art, control logic and/or automated routines for performing the techniques and steps described herein may be implemented by the user device 102 and the authentication device 104 either by hardware, software, or combinations of hardware and software. For example, suitable code may be accessed and executed by the one or more processors on the user device 102 and the authentication device 104 to perform some or all of the techniques described herein. Similarly, application specific integrated circuits (ASICs) configured to perform some, or all of the processes described herein may be included in the one or more processors on the user device 102 and the authentication device 104.

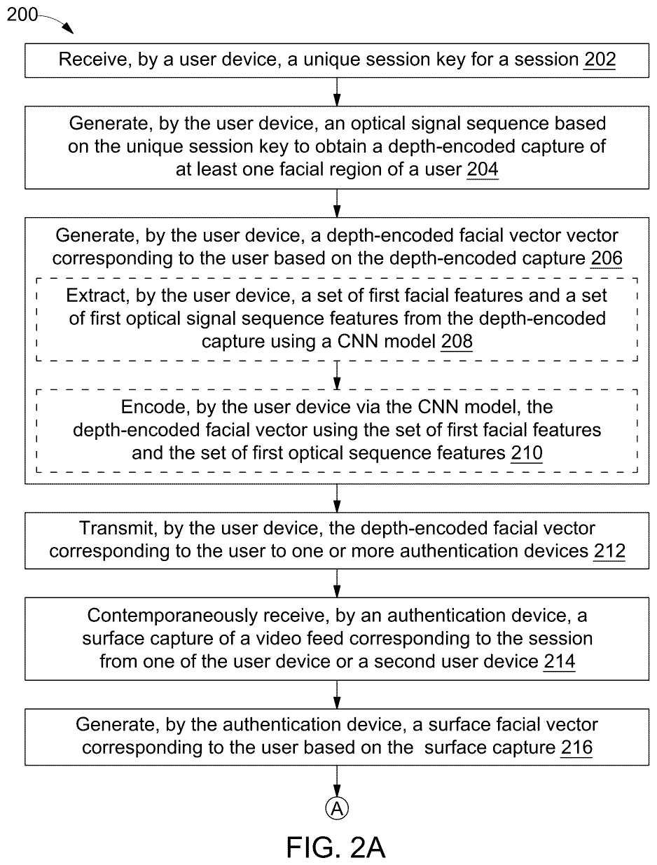

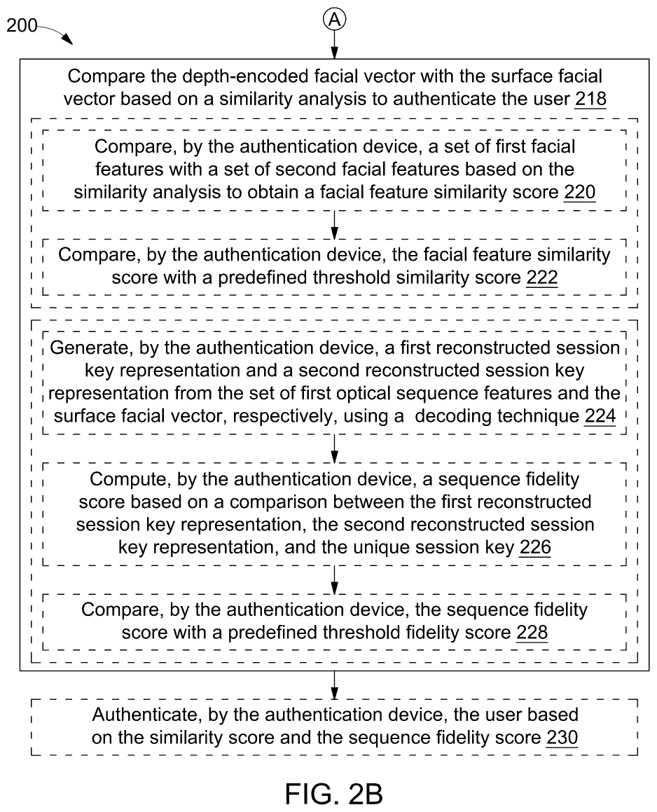

Referring now to FIG. 2, an exemplary process 200 for authentication of a user is illustrated via a flow chart, in accordance with some embodiments of the present disclosure. FIG. 2 is explained in conjunction with FIG. 1. The process 200 may be performed to authenticate the user on a video session. The video session may be between the user and one or more authenticators. Thus, the process 200 may be implemented by a user device (such as the user device 102) and one or more authentication devices (such as the authentication device 104). The process 200 may include receiving, by a receiving module (such as the receiving module 110), a unique session key for a session, at step 202. The unique session key may be received from an authentication device (such as the authentication device 104) or may be generated by a user device (such as the user device 102).

Upon receiving the unique session key, the process 200 may include generating, by an optical signal sequence generating module (such as the optical signal sequence generating module 112), an optical signal sequence based on the unique session key to obtain a depth-encoded capture of at least one facial region of a user, at step 204. It should be noted that the depth-encoded capture may include the optical signal sequence projected upon the at least one facial region of the user.

Further, the process 200 may include generating, by a CNN module (such as the CNN module 114), a depth-encoded facial vector corresponding to the user based on the surface capture using the CNN model, at step 206. It should be noted that the depth-encoded facial vector may include a set of first facial features and a set of first optical signal sequence features. The step 206 may include steps 208 and 210

To generate the depth-encoded facial vector, the process 200 may include extracting, by the CNN module, the set of first facial features and the set of first optical signal sequence features from the depth-encoder capture, at step 208. Further, the process 200 may include encoding, by the CNN module, the depth-encoded facial vector using the set of facial features and the set of optical signal sequence features, at step 210, The depth-encoded facial vector may include an entanglement of the set of first facial features with the set of optical signal sequence features, thereby enabling authentication based on depth validation, and comparison of the depth-encoded facial vector with a surface facial vector and the unique session key. The depth-encoded facial vector may be transformed through a rotation operation based on the unique session key.

In some embodiments, the process 200 may include extracting, by the CNN module, a set of geometrical features from the depth-encoded capture using the CNN model. In such embodiments, the process 200 may further include evaluating, by the CNN module, a depth corresponding to the at least one facial region of the user based on the set of geometrical features. Further, the process 200 may include transmitting, by a transmitting module (such as the transmitting module 116), the depth-encoded facial vector corresponding to the user to one or more authentication devices (such as the authentication device 104), at step 212.

Contemporaneously, the process 200 may include receiving, by a receiving module (such as the receiving module 124), the surface capture of a video feed corresponding to the session from one of the user device (such as the user device 102) or a second user device, at step 214. Upon receiving the surface capture of the video feed, the process 200 may include generating, by a CNN module (such as the CNN module 126), a surface facial vector corresponding to the user based on the surface capture, at step 216. It should be noted that the surface facial vector may include a set of second facial features and a set of second optical signal sequence features.

Further, the process 200 may include comparing, by a comparing module (such as the comparing module 128), the depth-encoded facial vector with the surface facial vector based on a similarity analysis to authenticate the user, at step 218. The step 218 may include steps 220, 222, 224, 226, 228, and 230.

To authenticate the user, the process 200 may include performing an identity match check. The identity match check may include comparing, by the comparing module, the set of first facial features with the set of second facial features based on the similarity analysis to obtain a similarity score, at step 220. Further, the identity match check may include comparing, by the comparing module, the similarity score with a predefined threshold similarity score, at step 222.

Contemporaneously, to authenticate the user, the process 200 may include performing a blink fidelity check. The blink fidelity check may include generating, by a decoding module (such as the decoding module 130), a first reconstructed session key representation and a second reconstructed session key representation from the set of first optical signal sequence features and the surface facial vector, respectively, using a decoding technique, at step 224. Upon generating the reconstructed session key, the process 200 may include computing, by the fidelity score computing module, a sequence fidelity score based on a comparison between the reconstructed session key and the unique session key, at step 226.

Further, the process 200 may include comparing, by the comparing module, the sequence fidelity score with a predefined threshold fidelity score, at step 228. Further, the process 200 may include authenticating, by an authenticating module (such as the authenticating module 132), the user based on the similarity score and the sequence fidelity score, at step 230.

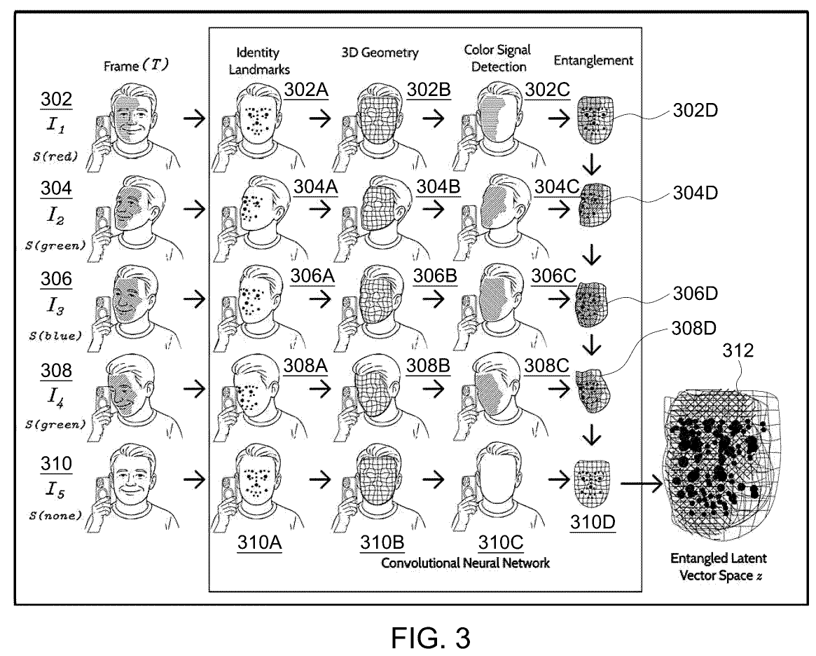

Referring now to FIG. 3, generation of a depth-encoded capture of facial regions of a user is illustrated, in accordance with some embodiments of the present disclosure. FIG. 3 is explained in conjunction with FIG. 1 and FIG. 2. As explained previously, the optical signal sequence generating module 112 may convert the unique session key into an optical signal sequence for a predefined time duration (e.g., 2 seconds, 5 seconds, 15 seconds, or the like). In an embodiment, the predefined time duration of a single optical signal sequence may be less than or equal to about 5 seconds. The optical signal sequence may be projected for a predefined number of times. For example, when the predefined number of times is set at 3, then an optical signal sequence with the predefined time duration of about 5 seconds may be projected for a total duration of about 15 seconds. The optical signal sequence may include timed and/or colored optical pulses (or modulations).

Further, the CNN module 114 may obtain a depth-encoded capture of at least one facial region of the user through at least one camera and a depth sensor of the user device. The depth-encoded capture may include the optical signal sequence projected upon the at least one facial region of the user and a depth map of the at least one facial region of the user. The optical signal sequence may be projected through a display or a flashlight of the user device or through a separately programmable light emitting device (i.e., a calibrated emitter array (LEDs, IR, audio transducers, etc.) for precise projection of the optical signal sequence. The calibrated emitter array may improve robustness across user devices and ambient conditions. To obtain the depth-encoded capture, the user may project the optical signal sequence onto the at least one facial region of the user. Contemporaneously, the user may scan (or capture) the at least one facial region projected upon by the optical signal sequence from multiple angles, via the at least one camera and the depth sensor, to obtain the depth-encoded capture. As will be appreciated, the depth-encoded capture, being a video capture, may include a plurality of frames. Once the depth-encoded capture of the at least one facial region is obtained, the CNN module 114 may process each of the plurality of frames of the depth-encoded capture to generate a depth-encoded facial vector using the CNN model 118. The user may keep the user device 102 in a stationary position relative to the face thereof, or may move it around the face to capture more facial regions.

By way of an example, a first frame 302 (e.g., ‘I1’) may include a first optical signal (e.g., red color) in the optical signal sequence projected onto an up-tilted frontal facial region of the user.

Similarly, a second frame 304 (e.g., ‘I2’) may include a second optical signal (e.g., green color) projected onto a side frontal facial region of the user.

A third frame 306 (e.g., ‘I3’) may include a third optical signal (e.g., blue color) projected onto a frontal facial region of the user.

A fourth frame 308 (e.g., ‘I4’) may include a fourth optical signal (e.g., green color) projected onto a down-tilted frontal facial region of the user.

A fifth frame 310 (e.g., ‘I5’) may include a fifth optical signal (e.g., no signal) projected onto the left-frontal facial region of the user.

Further, the CNN module 114 may process the plurality of frames to identify a set of facial features (or landmarks), a set of geometrical features (or 3D geometry), and a set of optical signal sequence features (e.g., a color of the optical signal) from each of the plurality of frames.

In continuation with the above example, from the first frame 302 ‘I1’, facial features 302A, geometrical features 302B and optical signal sequence features 302C (i.e., red color) may be identified.

In the same manner, from the second frame 304 ‘I2’, facial features 304A, geometrical features 304B and optical signal sequence features 304C (i.e., green color) may be identified.

From the third frame 306 ‘I3’, facial features 306A, a 3D facial geometrical features 306B and optical signal sequence features 306C (i.e., blue color) may be identified.

From the fourth frame 308 ‘I4’, facial features 308A, a 3D facial geometrical features 308B and optical signal sequence features 308C (i.e., green color) may be identified.

From the fifth frame 310 ‘I5’, facial features 310A, a 3D facial geometrical features 310B and optical signal sequence features 310C (i.e., no color) may be identified.

Once the facial features, the 3D geometry, and the color of the optical signal are identified, the CNN module 114 may combine the set of first facial features, the set of geometrical features and the set of optical signal sequence features to create an entanglement (i.e., the depth-encoded capture) of each frame.

In continuation with the above example, an entanglement 302D corresponding to the first frame 302 ‘I1’ may be obtained based on the combination of the facial features 302A, the geometrical features 302B, and the optical signal sequence features 302C.

In the same manner, an entanglement 304D corresponding to the second frame 304 ‘I2’ may be obtained based on the combination of the facial features 304A, the geometrical features 304B, and the optical signal sequence features 304C.

An entanglement 306D corresponding to the third frame 306 ‘I3’ may be obtained based on the combination of the facial features 306A, the geometrical features 306B, and the optical signal sequence features 306C.

An entanglement 308D corresponding to the fourth frame 308 ‘I4’ may be obtained based on the combination of the facial features 308A, the geometrical features 308B, and the optical signal sequence features 308C.

An entanglement 310D corresponding to the fifth frame 310 ‘I5’ may be obtained based on the combination of the facial features 310A, the geometrical features 310B, and the optical signal sequence features 310C. It should be noted that the since the color of the optical signal 310C is none in the fifth frame 310, the entanglement 310D effectively only includes the facial features 310A and the geometrical features 310B of the user.

Further, the CNN module 114 may convert the entanglement corresponding to each frame into a depth-encoded facial vector 312 (i.e., an entangled latent vector space) corresponding to the at least one facial region of the user. In particular, the depth-encoded facial vector 312 may be generated based on vectorized combination of each of the entanglement 302D, the entanglement 304D, the entanglement 306D, the entanglement 308D, and the entanglement 310D. The depth-encoded facial vector 312 may then enable authentication based on depth-validation, and comparison of the depth-encoded facial vector with a surface facial vector and the unique session key.

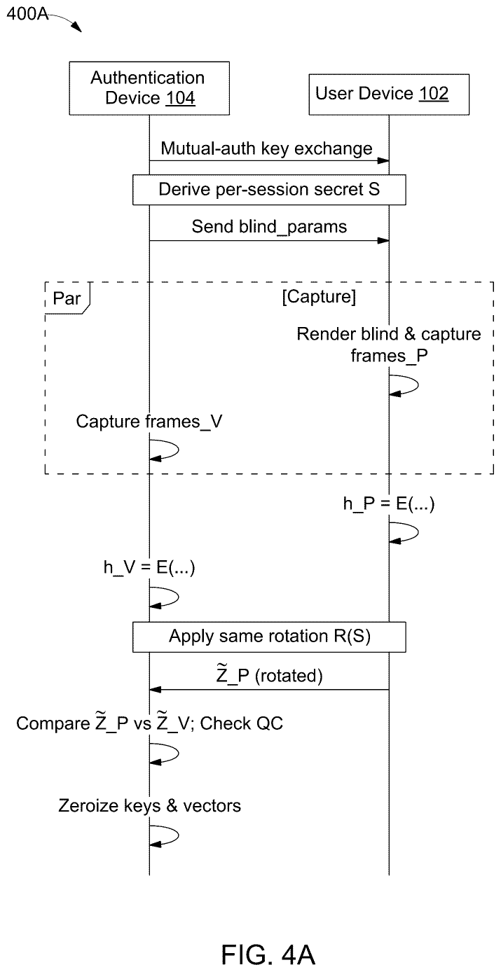

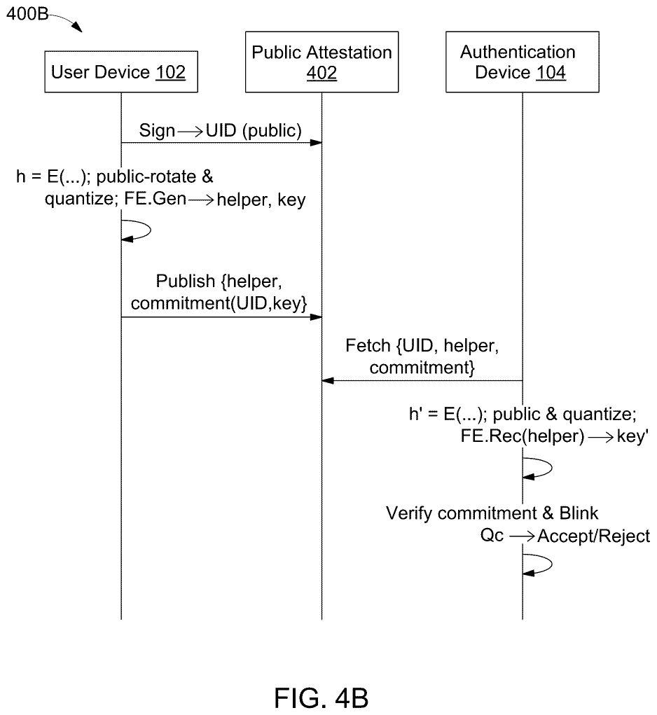

Referring now to FIGS. 4A and 4B, communication flow diagrams between the user device 102 and the authentication device 104 for authentication of a user are illustrated, in accordance with some embodiments of the present disclosure. FIGS. 4A and 4B are explained in conjunction with FIGS. 1-3. In FIG. 4A, an authenticator-initiated (i.e., verifier-initiated) user authentication is shown. Initially, the authentication device 104 performs a handshake to establish a connection with the user device 102. During the handshake, a mutual-auth key exchange (e.g., X25519/Noise) takes place. During authentication, the authenticator will generate a random number and send the random number from the authentication device 104 with the presenter. In an embodiment, the exchange of the random number may be in form of a message that the authenticator initiates. The unique session key may be a per-session secret (i.e., unique for each session between the authenticator and the user).

If a TIP is used, the exchange of the encrypted identity bundle is used to establish a shared secret between the authenticator and the user. Further, from the shared secret, the session key can be derived independently by both the authenticator and the user. The random number is still passed (to ensure that the verification is contemporaneous) so the unique session key may then be a predefined number of bits (e.g., first 20 bits) of the random number multiplied by the shared secret.

Further, the authentication device 104 may send a set of blink parameters to the user device 102. The set of blink parameters may include a configuration for converting the unique session key into an optical signal sequence (i.e., blink sequence). Further, the user device 102 may generate the optical signal sequence. The optical signal sequence may then be rendered through the screen of the user device or through another programmable light source. The user may then obtain a depth-encoded capture (frames_P) by using the user device 102 to record (or capture) at least one facial region of the user while the user projects the optical signal sequence on the at least one facial region. Contemporaneously, the authenticator may also obtain a surface facial capture (frames_V) by using the authentication device 104 to record the video feed of the user projecting the optical signal sequence on the at least one facial region.

Further, a depth-encoded facial vector (h_P) may be obtained from the depth-encoded capture (frames_P) using a CNN model in the user device 102. The depth-encoded facial vector (h_P) may be an entanglement of facial features, optical signal sequence features, and geometrical features extracted from the depth-encoded capture (frames_P). Similarly, a surface facial vector (h_V) may be obtained from the surface facial capture (frames_V) using a CNN model in the authentication device 104. The surface facial vector (h_V) may be an entanglement of facial features and optical signal sequence features extracted from the surface facial capture (frames_V).

Further, the user device 102 and the authentication device 104 may build an orthogonal rotation R(S) (deterministic) and may apply the same orthogonal rotation to the depth-encoded facial vector (h_P) and the surface facial vector (h_V). The orthogonal rotation R(S) may be based on the unique session key. Thus, a rotated depth-encoded facial vector (\tilde{z}_P) and a rotated surface facial vector (\tilde{z}_V) may be obtained. In an embodiment, the unique session key may be derived from the shared secret multiplied by a random number. Thus, to decipher the rotated depth-encoded facial vector (\tilde{z}_P) and the rotated surface facial vector (\tilde{z}_V), both the derived key and the random number may be required from a device. In other words, the orthogonal rotation R(S) provides a from of encryption to the latent vector space. Further, the user device 102 may send the rotated depth-encoded facial vector (\tilde{z}_P) to the authentication device 104.

The authentication device 104 may compare the rotated depth-encoded facial vector (\tilde{z}_P) with the rotated surface facial vector (\tilde{z}_V) based on a cosine distance. In some embodiments, prior to comparing, the rotated depth-encoded facial vector (\tilde{z}_P) and the rotated surface facial vector (\tilde{z}_V) may be de-rotated based on the unique session key to obtain the depth-encoded facial vector (h_P) with the surface facial vector (h_V). When the cosine distance is above a predefined threshold, the check for identity match is established as successful. When the cosine distance is below a predefined threshold, the check for identity match is established as unsuccessful. Optionally, one of the user device 102 or the authentication device 104 may check for a 3D depth in the depth-encoded facial vector (h_P) to perform a depth check of the user.

Additionally, the authentication device 104 may decode (QC) the optical signal sequence from each of the depth-encoded facial vector (\tilde{z}_P) with the surface facial vector (\tilde{z}_V) based on HSV/Hue features extraction, optical color segmentation, inter-key delimiter and repetition search, CRC/FEC check, and offset/latency/timing check. Thus, a first reconstructed session key representation and a second reconstructed session key representation may be obtained from decoding of the depth-encoded facial vector (\tilde{z}_P) and the surface facial vector (\tilde{z}_V), respectively. Each of the first reconstructed session key representation and the second reconstructed session key is compared with the unique session key based on a blink fidelity score (such as a cosine distance). When the blink fidelity score is above a predefined threshold, the check for blink fidelity (i.e., QC) is established as successful. When the blink fidelity score is below a predefined threshold, the check for blink fidelity (i.e., QC) is established as unsuccessful.

Immediately upon completing the various authentication checks, the authentication device 104 may zeroize (or delete) the unique session key, the surface facial capture (frames_V), the depth-encoded facial vector (\tilde{z}_P), and the surface facial vector (\tilde{z}_V).

In FIG. 4B, a user-initiated (i.e., presenter-initiated) self-authentication is shown. The authenticator may post a signed attestation on a public attestation network 402 through the user device 102 to generate a public UID. Thus, for the presenter-initiated self-authentication, the UID acts as the unique session key. In other words, the UID defines the optical signal sequence. Further, the user device 102 generates the optical signal sequence and obtains the depth-encoded capture (frames_P) in a similar manner as explained for the authenticator-initiated user authentication.

Further, the user device 102 converts the depth-encoded capture (frames_P) into a depth-encoded facial vector (h_P) using a CNN model. Further, the user device 102 generates a bounded-use representation of the depth-encoded facial vector (h_P). The bounded-use representation is generated using a public canonical rotation of the depth-encoded facial vector (h_P) based on the UID, quantization of the depth-encoded facial vector (h_P) to a bit sketch, and then applying a fuzzy extractor. The bounded-use representation of the depth-encoded facial vector (h_P) may be in a form of helper data and a commitment.

The user device 102 then publishes the bounded-use representation ({helper, commitment(UID, key)}) to the public attestation network 402. Further, any viewer may fetch the bounded-use representation ({helper, commitment(UID, key)}) via an authentication device (such as the authentication device 104). The authentication device 104 may then compute a local surface facial vector (h′) based on the video feed of the user. Further, the authentication device 104 may apply the same public canonical rotation based on the UID to the local surface facial vector (h′). Further, the authentication device 104 may quantize the local surface facial vector (h′) and recover the unique session key via the helper to obtain a reconstructed session key representation. Further, the authentication device 104 may verify the commitment, and perform the QC to check the blink fidelity in a similar manner as explained for the authenticator-initiated user authentication.

Referring now to FIG. 5, a detailed exemplary control logic 500 for training a blink decoder for reconstructing session key representations from depth-encoded vectors is illustrated via a flow chart, in accordance with some embodiments of the present disclosure. FIG. 5 is explained in conjunction with FIG. 1-4A-B. Once the depth-encoded capture is obtained, the CNN module 114 may generate the depth-encoded facial vector 312 corresponding to the user based on the depth-encoded capture using the CNN model 118.

To generate the depth-encoded facial vector 312, the CNN module 114 may extract a set of first facial features 502 and a set of first optical signal sequence features 504 from each of the plurality of frames of the depth-encoded capture. Further, the CNN model 118 may entangle the set of first facial features 502 with the set of first optical signal sequence features 504 to generate the depth-encoded facial vector 312. The depth-encoded facial vector 312 is further transformed using a rotation operation based on the unique session key (as explained in conjunction with FIGS. 4A and 4B).

Further, the transmitting module 116 may send the depth-encoded facial vector 312 to the receiving module 124 of the authentication device 104. Further, the decoding module 130 of the authentication device 104 may generate a first reconstructed session key representation based on the first optical signal sequence features 504 of the depth-encoded facial vector 312, using a blink decoder 506.

During training stage of the blink decoder 506, the comparing module 128 may compare the first reconstructed session key representation with an original session key 508 (k_{target}) to compute a blink reconstruction loss 510. The blink reconstruction loss 510 may then be used to train the blink decoder 506. During inference stage of the blink decoder 506, the comparing module 128 may compare the first reconstructed session key representation with the original session key 508 to verify a blink fidelity during the inference.

Referring now to FIG. 6, a detailed exemplary control logic 600 for comparison of the depth-encoded facial vector 312 with a surface facial vector is illustrated via a flow chart, in accordance with some embodiments of the present disclosure. FIG. 6 is explained in conjunction with FIG. 1-5. Upon receiving the depth-encoded facial vector 312, the receiving module 124 may contemporaneously receive a surface capture of a video feed corresponding to the session from the one of the user device 102 or a second user device. Further, the CNN module 126 may generate, via the CNN model 136, a surface facial vector 602 corresponding to the user based on the surface capture. The surface facial vector 602 may include a set of second facial features and a set of second optical signal sequence features. Further, the CNN module 126 may send the surface facial vector 602 to the comparing module 128.

Further, the comparing module 128 may perform a series of checks on the depth-encoded facial vector 312 and the surface facial vector 602 based on a similarity analysis between the depth-encoded facial vector 312 and the surface facial vector 602. The series of checks may include a check for identity match 604, a check for blink fidelity 606, and a check for 3D depth 608. The depth-encoded facial vector 312 may be received from the receiving module 124.

To compare the depth-encoded facial vector 312 with the surface facial vector 602, the comparing module 128 may compare the set of first facial features 502 with the set of second facial features based on a similarity analysis (e.g., cosine similarity) to obtain a facial feature similarity score.

Further, the comparing module 128 may compare the facial feature similarity score with a predefined threshold similarity score. The predefined similarity score may fall within the range of (0-1). By way of an example, when the facial feature similarity score is above the predefined threshold similarity score, the set of first facial features 502 may be established as matching with the set of second facial features. In this scenario, the check for identity match 604 may be successful. By way of another example, when the similarity score is below the predefined threshold similarity score, in such cases, the set of first facial features 502 may not be established as matching with the set of second facial features of the user. In this scenario, the check for identity match 604 may be unsuccessful.

Contemporaneously, the decoding module 130 may generate a first reconstructed session key representation and a second reconstructed session key representation from the depth-encoded facial vector 312 and the surface facial vector 602, respectively, using a decoding technique. Further, the decoding module 130 may compute a sequence fidelity score based on comparison among the first reconstructed session key representation, the second reconstructed session key representation, and the original session key. Further, the decoding module 130 may compare the sequence fidelity score with a predefined fidelity score. The predefined fidelity score may fall within the range of (0-1). By way of an example, when the sequence fidelity score is above the predefined fidelity score, the check for blink fidelity 506 may be successful. By way of another example, when the sequence fidelity score is below the predefined fidelity score, the check for blink fidelity 506 may be unsuccessful.

In some embodiments, prior to transmitting the depth-encoded facial vector 312 to the authentication device 104, the CNN module 114 of the user device 102 may perform the check for 3D depth 608 on the depth-encoded facial vector 312 to confirm that the user is a physical 3D source.

Further, the authenticating module 132 may authenticate the user based on the similarity score and the sequence fidelity score. To authenticate the user, the authenticating module 132 may combine the similarity score and the sequence fidelity score to obtain a combined score. Further, the authenticating module 132 may compare the combined score with a distance threshold 610 to authenticate the user.

By way of an example, when the combined score above the distance threshold 610, the user authentication may be successful. On the other hand, when the combined score is below the distance threshold 610, the user authentication may be unsuccessful.

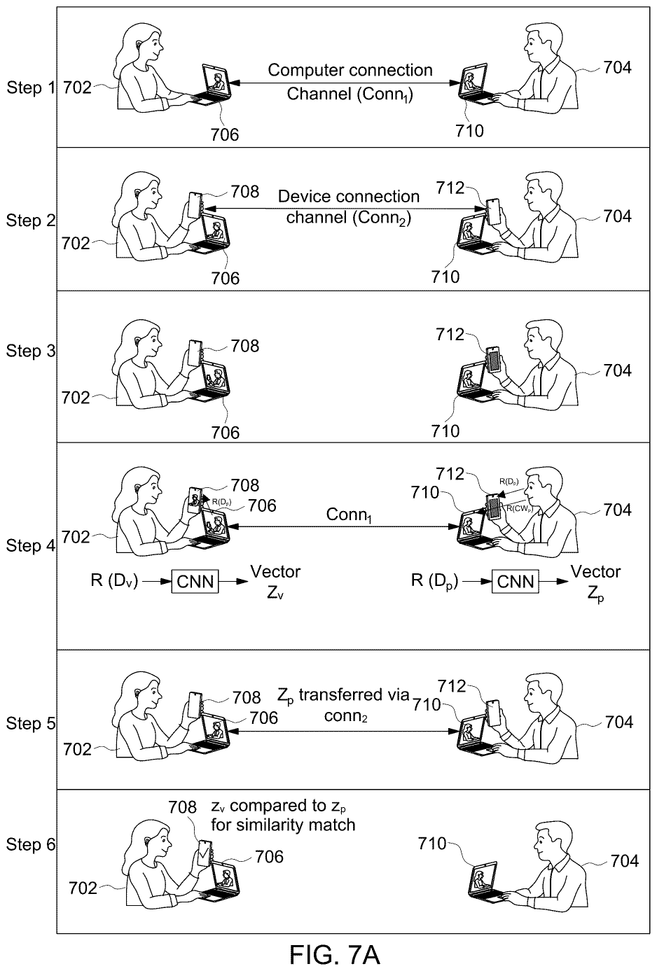

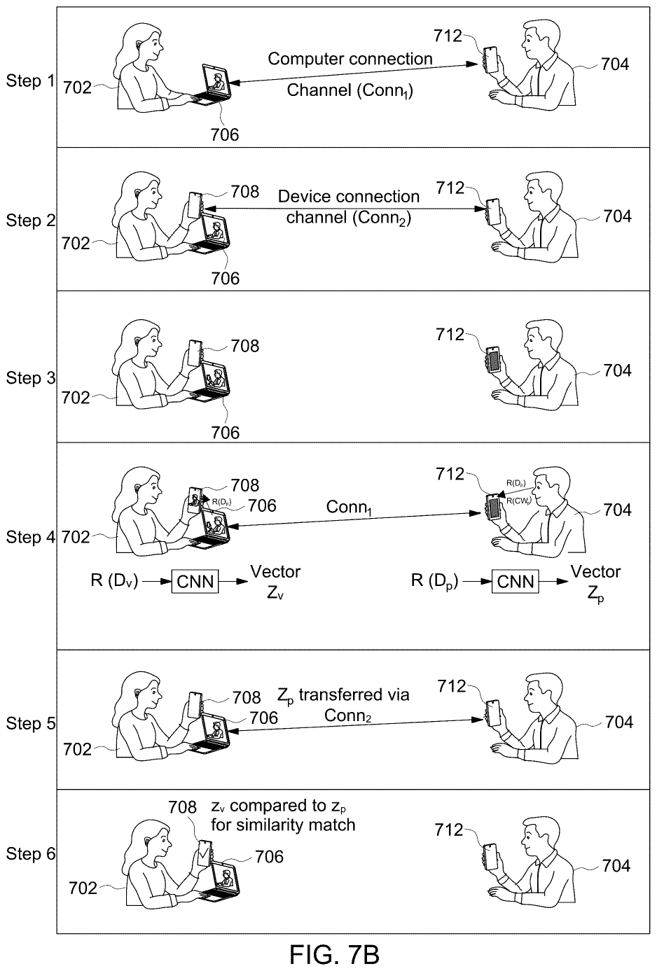

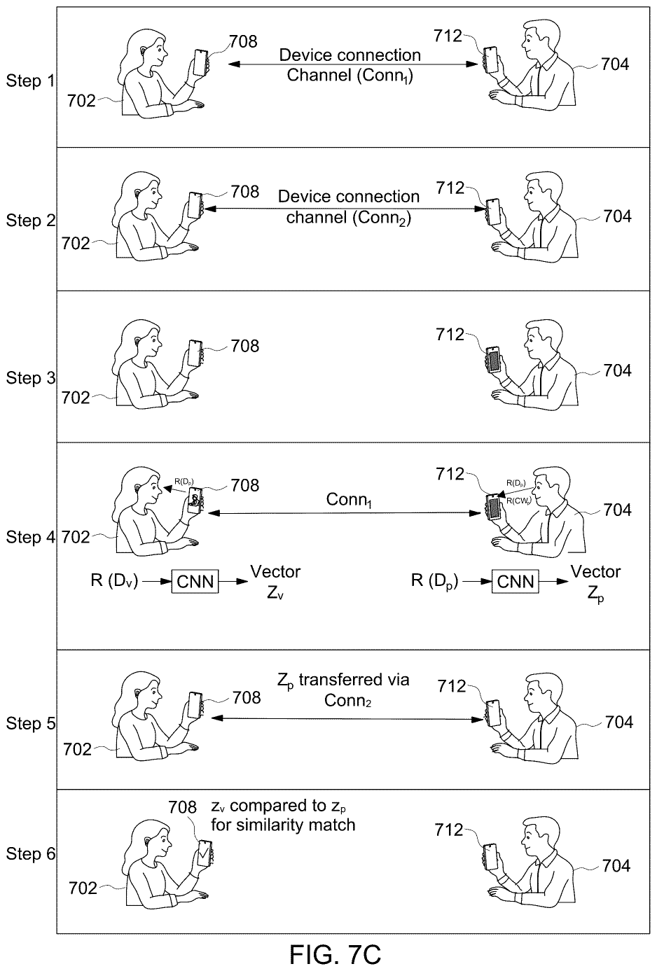

Referring now to FIGS. 7A, 7B, and 7C, exemplary scenarios for authenticator-initiated user authentication are illustrated, in accordance with some embodiments of the present disclosure. In FIG. 7A, a verifier 702 (i.e., the authenticator) and a presenter 704 (i.e., the user) may be participants in a video session. The verifier 702 may operate two authentication devices (e.g., a verifier laptop 706 and a verifier smartphone 708) during the video session. Additionally, the presenter 704 may operate two user devices (e.g., a presenter laptop 710 and a presenter smartphone 712) during the video session.

The verifier 702 and the presenter 704 may participate in the video session through the verifier laptop 706 and the presenter laptop 710, respectively. Each of the verifier laptop 706 and the presenter laptop 710 may include a camera and a screen (i.e., display) for capturing and displaying video streams, respectively.

The verifier smartphone 708 may be used to authenticate the presenter 704 during the video session. The verifier smartphone 708 may be analogous to the authentication device 104. The verifier smartphone 708 may include a camera for capturing the video feed of the presenter 704 displayed on the screen of the verifier laptop 706. The verifier smartphone 708 may further include a screen. The screen may be used to display an authentication status (e.g., successful or failure).

The verifier smartphone 708 may further include a processing unit (not shown). The processing unit may be used to run multiple checks (e.g., a blink fidelity, an identity match, a temporal consistency, and a 3D verification) on the received depth-encoded facial vector (analogous to the depth-encoded facial vector 312) and the surface facial vector extracted from the video feed to authenticate the presenter 704.

In an embodiment, the verifier smartphone 708 may be configured for an enhanced blink sequence (i.e., optical signal sequence) detection. The configuration for enhanced blink sequence detection may include incorporating the verifier smartphone 708 with a camera with a high dynamic range and frame rate, potentially with the optical filters. In such a configuration, the camera may be specifically optimized to robustly detect and decode the blink sequence from a distance and across various ambient lighting conditions and video compression levels. The verifier smartphone 708 may further be configured for secure processing for verification logic. The configuration for secure processing may include a hardware support for securely executing the verification algorithms and comparisons involving depth-encoded facial vectors.

The presenter smartphone 712 may include a camera. The camera may be used to scan 3D facial region of the presenter 704. The presenter smartphone 712 may further include a screen. The screen may be used for self-projection of the blink sequence. Additionally, the screen may be used to display a set of instructions received from the verifier smartphone 708.

The presenter smartphone 712 may further include a processing unit (not shown). The processing unit may be configured to execute a CNN encoder (analogous to the CNN model 118) for generating the depth-encoded facial vector (or the entangled latent vector). In some embodiments, the presenter smartphone 712 may further include a secure element (or secure enclave). The secure element may be used to store cryptographic keys and sensitive data, signing operations for TIPs or attestations, isolated from the main operating system. In an embodiment, the presenter smartphone 712 may further include an optimized imaging system. The optimized imaging system may include multiple cameras for improved 3D depth perception, specialized sensors (e.g., IR depth sensors, or the like) for better facial geometry capture robust to varied lighting and higher frame rate capabilities. The presenter smartphone 712 may further include an integrated calibrated light source. The integrated calibrated light source may be a dedicated, precisely controlled array of LEDs for projecting the blink sequence, offering superior temporal accuracy, color fidelity, and intensity control compared to a general-purpose screen. The integrated calibrated light source may also be designed to minimize user discomfort or visual fatigue. The presenter smartphone 712 may further include a hardware-accelerated CNN encoder. A specialized Application Specific Integrated Circuit (ASIC) or Field Programmable Gate Array (FPGA) may be used for the CNN model to ensure rapid and power-efficient depth-encoded facial vector generation. The presenter smartphone 712 may further include a tamper-resistant secure enclave. The tamper-resistant secure enclave may provide secure environments for all the cryptographic operations, sensor data, processing, model execution, and key management, providing a higher degree of security assurance.

At step 1, the video session is initiated. A first communication channel (Conn₁) may be established between the verifier laptop 706 and the presenter laptop 710. Video streams of the verifier 702 and the presenter 704 may be exchanged through the first communication channel. Additionally, the verifier 702 may initiate the user authentication through the verifier smartphone 708. A request may be sent to the presenter smartphone 712 to obtain a consent from the presenter 704 to initiate the user authentication. Upon obtaining the consent, a second communication channel (Conn₂) may be established between the verifier smartphone 708 and the presenter smartphone 712.

At step 2, the verifier smartphone 708 may generate a unique session key (k). Optionally, the unique session key may be derived from a previously established shared secret between the verifier 702 and the presenter 704. Further, the verifier 702 may share the unique session key with the presenter 704 through the second communication channel. At step 3, the presenter smartphone 712 may convert the unique session key into a blink sequence S(k) using pre-established conversion parameters (e.g., a blink rate of 20 ms, optical signal color green=0, optical signal color blue=1, and optical signal color red=end of sequence). It should be noted that the blink sequence is same as the optical signal sequence.

At step 4, the presenter smartphone 712 may start projecting the blink sequence through the screen thereof. The presenter 704 may direct the screen towards at least one facial region of the presenter 704 when the blink sequence is being projected. Contemporaneously, the presenter 704 may start scanning the at least facial region illuminated by the blink sequence, using the camera. Preferably, the camera is on the same side of the presenter smartphone 712 as the screen so as to contemporaneously project the blink sequence on the at least one facial region and scan (or record) the at least one facial region. When the presenter 704 scans the at least one facial region using the camera, a 3D scan R(Dₚ) of the at least one facial region of the presenter 704 is obtained. It should be noted that the 3D scan is same as the depth-encoded capture. Contemporaneously, the presenter laptop 710 may start recording a video feed of the presenter 704 while scanning the 3D facial region, using the camera.

Contemporaneously, the presenter laptop 710 may broadcast the video feed of the presenter 704 performing the 3D scan to the verifier 702 on the verifier laptop 706. The verifier 702 may obtain a 2D scan R(Dᵥ) of the video feed of the presenter 704being displayed on the screen of the verifier laptop 706 using the verifier smartphone 708. It should be noted that the 2D scan is same as the surface facial capture.

Further, the presenter smartphone 712 may convert the 3D scan R(Dₚ) of the presenter 704 into a 3D facial region vector zₚ (analogous to the depth-encoded facial vector) using a CNN model. On the other hand, the verifier smartphone 708 may convert the 2D scan R(Dᵥ) of the at least one facial region of the presenter 704 into a 2D facial region vector zᵥ (analogous to the surface facial vector), using a CNN model.

At step 5, once the scanning is completed, the presenter smartphone 712 may send the 3D facial region vector to the verifier smartphone 708. At step 6, the verifier smartphone 708 may compare the 3D facial region vector zₚ with the 2D facial region vector zᵥ based on various checks (such as, a fidelity check, a similarity check, and a 3D geometry check) to authenticate the presenter 704. This is already explained in greater detail in conjunction with FIG. 6.

When all the checks are performed successfully (i.e., a combined score is within a distance threshold), the verifier smartphone 708 may render a message corresponding to successful user authentication of the presenter 704. Alternatively, when the checks are unsuccessful (i.e., the combined score is beyond the distance threshold), the verifier smartphone 708 may render a message corresponding to unsuccessful user authentication of the presenter 704.

In FIG. 7B, the verifier 702 may operate two authentication devices (i.e., the verifier laptop 706 and the verifier smartphone 708) during the video session. Additionally, the presenter 704 may operate a single user device (i.e., the presenter smartphone 712) during the video session. At step 1, the video session may be initiated between the verifier 702 and the presenter 704. The first communication channel (Conn₁) may be established between the verifier laptop 706 and the presenter smartphone 712. Video streams of the verifier 702 and the presenter 704 may be exchanged through the first communication channel.

At step 2, the user authentication of the presenter 704 may be initiated. The second communication channel (Conn₂) may be established between the verifier smartphone 708 and the presenter smartphone 712. The verifier 702 may share the unique session key (k) with the presenter 704 through the second communication channel. At step 3, the presenter smartphone 712 may convert the session key (k) into a blink sequence S(k). At step 4, the presenter 704 may use the presenter smartphone 712 to project the blink sequence on at least one facial region and to contemporaneously scan the at least one facial region upon which the blink sequence is being projected. The presenter 704 may then obtain a 3D scan R(Dₚ). The presenter smartphone 712 may then convert the 3D scan R(Dₚ) into a 3D facial region vector zₚ using a CNN model. Additionally, the verifier 702 may use the verifier smartphone 708 to record the video feed of the presenter 704 projecting the blink sequence on the at least one facial region, as displayed on the verifier laptop 706. The verifier 702 may then obtain a 2D scan R(Dᵥ). The verifier smartphone 708 may then convert the 3D scan R(Dᵥ) into a 2D facial region vector zᵥ using a CNN model.

At step 5, the presenter 702 may use the presenter smartphone 712 to send the 3D facial region vector zₚ to the verifier smartphone 708 via the second communication channel. At step 6, the verifier smartphone 708 may compare the 3D facial region vector zₚ with the 2D facial region vector zᵥ to authenticate the user.

In FIG. 7C, the verifier 702 may operate a single authentication device (i.e., the verifier smartphone 708) during the video session. Additionally, the presenter 704 may also operate a single user device (i.e., the presenter smartphone 712) during the video session. At step 1, the video session may be initiated between the verifier 702 and the presenter 704. The first communication channel (Conn₁) may be established between the verifier smartphone 708 and the presenter smartphone 712. Video streams of the verifier 702 and the presenter 704 may be exchanged through the first communication channel.

At step 2, the user authentication of the presenter 704 may be initiated. The second communication channel (Conn₂) may be established between the verifier smartphone 708 and the presenter smartphone 712. The verifier 702 may share the unique session key (k) with the presenter 704 through the second communication channel. At step 3, the presenter smartphone 712 may convert the session key (k) into a blink sequence S(k). At step 4, the presenter 704 may use the presenter smartphone 712 to project the blink sequence on at least one facial region and to contemporaneously scan the at least one facial region upon which the blink sequence is being projected. The presenter 704 may then obtain a 3D scan R(Dₚ). The presenter smartphone 712 may then convert the 3D scan R(Dₚ) into a 3D facial region vector zₚ using a CNN model. Additionally, the verifier 702 may use the verifier smartphone 708 to capture the video feed of the presenter 704 projecting the blink sequence on the at least one facial region, from the video session (for example, through screen recording). The verifier 702 may then obtain a 2D scan R(Dᵥ). The verifier smartphone 708 may then convert the 3D scan R(Dᵥ) into a 2D facial region vector zᵥ using a CNN model.

At step 5, the presenter 702 may use the presenter smartphone 712 to send the 3D facial region vector zₚ to the verifier smartphone 708 via the second communication channel. At step 6, the verifier smartphone 708 may compare the 3D facial region vector zₚ with the 2D facial region vector zᵥ to authenticate the user.

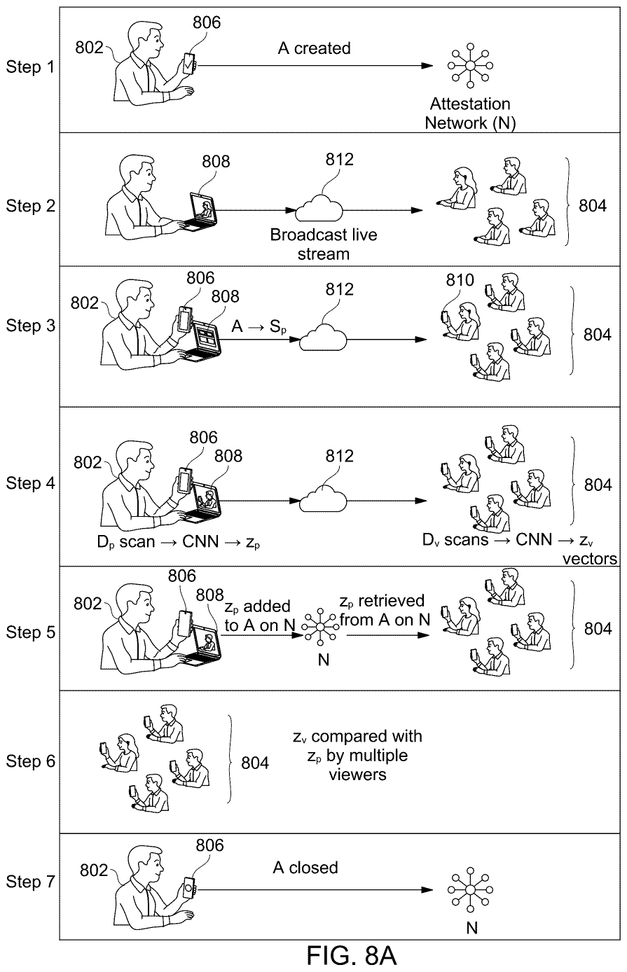

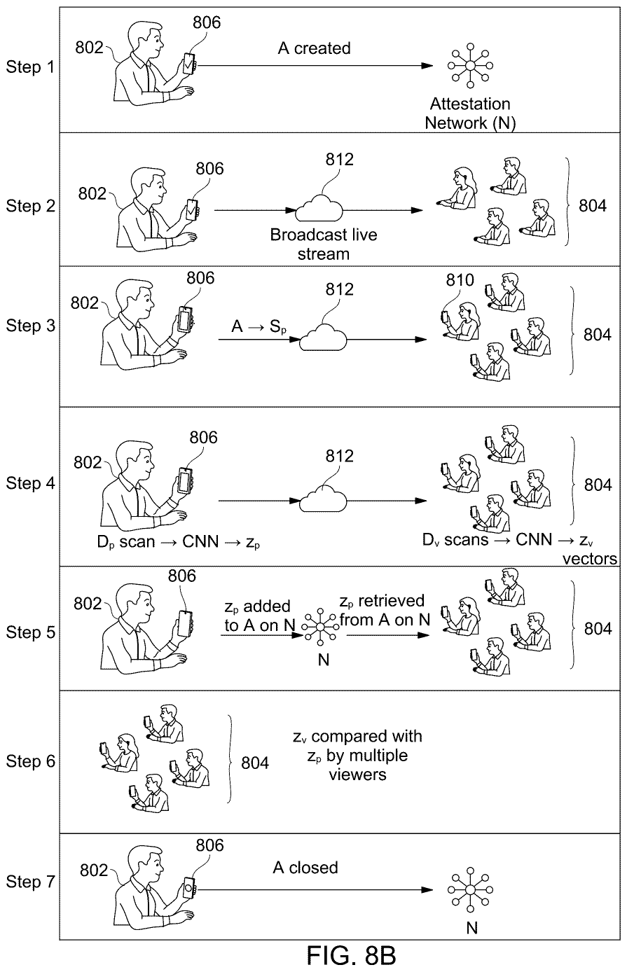

Referring now to FIGS. 8A and 8B, exemplary scenarios for user-initiated self-authentication, in accordance with some embodiments of the present disclosure. FIGS. 8A and 8B are explained in conjunction with FIGS. 1-7A-C. A presenter 802 in a video session may initiate a self-authentication process for a plurality of verifiers 804. By way of an example, the presenter 802 may be on a public live stream or may be releasing a pre-recorded video. Thus, the presenter 802 may initiate a self-authentication process for the plurality of viewers 804. The self-authentication process may be implemented entirely in real-time or may be completed any time after the video session. In other words, the presenter 802 may or may not be present at the time when the self-authentication process, as described by way of following scenarios, is completed.

In FIG. 8A, the presenter 802 may operate two user devices (i.e., the presenter smartphone 806 and the presenter laptop 808) during the video session. Each of the plurality of verifiers 804 may operate a single authentication device (for example, a verifier smartphone 810) during the video session. At step 1, the presenter 802 may create an attestation ID (A) in an attestation network using their digital identity (e.g., digital signature) using the presenter smartphone 806.

At step 2, the presenter 802 may initiate a live broadcast with one or more of the plurality of verifiers using the presenter laptop 808, via a server 812. At step 3, the presenter 802 may retrieve a session UID and a unique session key Sₚ from the attestation network based on the attestation ID (A). Once the unique session key Sₚ is obtained, the presenter 802 may transmit the unique session key Sₚ to the server 812, via the presenter smartphone 806. Further, each of the plurality of verifiers 804 may independently retrieve the unique session key Sₚ from the server 812 during the broadcast or any time after the broadcast (based on a presence of time limit for expiry of the unique session key Sₚ defined by the presenter).

At step 4, the authentication may begin. The presenter smartphone 806 may convert the unique session key Sₚ into a blink sequence. Further, the screen of the presenter smartphone 806 may start projecting the blink sequence. While the blink sequence is being projected, the presenter 802 may direct the screen of the presenter smartphone 806 towards at least one facial region and may scan the at least one facial region, using a camera of the presenter smartphone 806. Further, the presenter smartphone 806 may record a 3D scan Dₚ of the at least one facial region of the presenter 802 being illuminated by the blink sequence. Further, the presenter smartphone 806 may convert the 3D scan Dₚ into a 3D facial region vector zₚ using a CNN model.

Additionally, for each of the plurality of verifiers 804, the verifier smartphone may capture a video feed of the presenter 802 projecting the blink sequence on the at least one facial region to obtain a 2D scan Dᵥ. Further, the verifier smartphone may convert the 2D scan Dᵥ into a 2D facial region vector zᵥ using a CNN model. Thus, a plurality of 2D facial region vectors zᵥ may be obtained.

At step 5, once the scanning is completed, the presenter 802 may store the 3D facial region vector zₚ in a storage corresponding to the attestation ID (A) on the attestation network (N) using the presenter smartphone 806. Further, each of the plurality of verifiers 804 may retrieve the 3D facial region vector zₚ from the storage corresponding to the attestation ID (A) on the attestation network using the verifier smartphone. At step 6, each verifier smartphone may compare the 3D facial region vector zₚ with the respective 2D facial region vector zᵥ for authentication of the presenter 802 based on checks for identity match, blink fidelity match, and depth match.

When the checks are successful (i.e., a combined score is within a distance threshold), the verifier smartphone may render a message corresponding to successful user authentication of the presenter 802. Alternatively, when the checks are unsuccessful (i.e., the combined score is beyond the distance threshold), the verifier smartphone may render a message corresponding to unsuccessful user authentication of the presenter 802. Optionally, at step 7, the presenter 802 may close the attestation using the presenter smartphone 806 revoking the permission for a public verifier to authenticate the presenter 802.

In FIG. 8B, the presenter 802 may operate a single user device (i.e., the presenter smartphone 806) during the video session. Each of the plurality of verifiers 804 may operate a single authentication device (for example, the verifier smartphone 810) during the video session. At step 1, the presenter 802 may create an attestation ID (A) in an attestation network using their digital identity (e.g., digital signature) using the presenter smartphone 806.

At step 2, the presenter 802 may initiate a live broadcast with one or more of the plurality of verifiers using the presenter smartphone 806, via the server 812. At step 3, the presenter 802 may retrieve a session UID and a unique session key Sₚ from the attestation network based on the attestation ID (A). Further, the presenter 802 may transmit the unique session key Sₚ to the server 812, via the presenter smartphone 806. Further, each of the plurality of verifiers 804 may independently retrieve the unique session key Sₚ from the server 812.

At step 4, the authentication may begin. The presenter smartphone 806 may convert the unique session key Sₚ into a blink sequence. Further, the screen of the presenter smartphone 806 may start projecting the blink sequence. While the blink sequence is being projected, the presenter 802 may direct the screen of the presenter smartphone 806 towards at least one facial region and may scan the at least one facial region, using a camera of the presenter smartphone 806. Further, the presenter smartphone 806 may record a 3D scan Dₚ of the at least one facial region of the presenter 802 being illuminated by the blink sequence. Further, the presenter smartphone 806 may convert the 3D scan Dₚ into a 3D facial region vector zₚ using a CNN model.

Additionally, for each of the plurality of verifiers 804, the verifier smartphone may capture a video feed of the presenter 802 projecting the blink sequence on the at least one facial region to obtain a 2D scan Dᵥ. Further, the verifier smartphone may convert the 2D scan Dᵥ into a 2D facial region vector zᵥ using a CNN model. Thus, a plurality of 2D facial region vectors zᵥ may be obtained.

At step 5, the presenter 802 may store the 3D facial region vector zₚ in a storage corresponding to the attestation ID (A) on the attestation network (N) using the presenter smartphone 806. Further, each of the plurality of verifiers 804 may retrieve the 3D facial region vector zₚ from the storage corresponding to the attestation ID (A) on the attestation network using the verifier smartphone. At step 6, each verifier smartphone may compare the 3D facial region vector zₚ with the respective 2D facial region vector zᵥ for authentication of the presenter 802 based on checks for identity match, blink fidelity match, and depth match to authenticate the presenter 802. Optionally, at step 7, the presenter 802 may close the attestation using the presenter smartphone 806 revoking the permission for a public verifier to authenticate the presenter 802.

As will be also appreciated, the above-described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

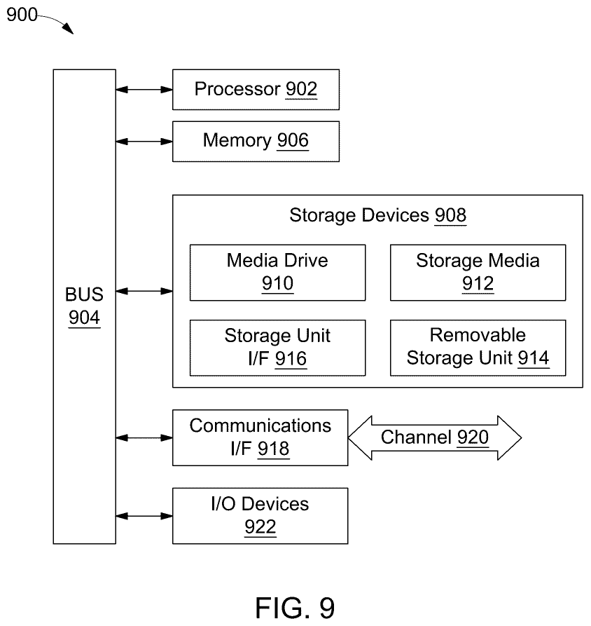

The disclosed methods and systems may be implemented on a conventional or a general-purpose computer system, such as a personal computer (PC) or server computer. Referring now to FIG. 9, an exemplary computing system 900 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 900 may represent, for example, a user device such as a desktop, a laptop, a mobile phone, personal entertainment device, DVR, and so on, or any other type of special or general-purpose computing device as may be desirable or appropriate for a given application or environment. The computing system 900 may include one or more processors, such as a processor 902 that may be implemented using a general or special purpose processing engine such as, for example, a microprocessor, microcontroller or other control logic. In this example, the processor 902 is connected to a bus 904 or other communication medium. In some embodiments, the processor 902 may be an Artificial Intelligence (AI) processor, which may be implemented as a Tensor Processing Unit (TPU), or a graphical processor unit, or a custom programmable solution Field-Programmable Gate Array (FPGA).

The computing system 900 may also include a memory 906 (main memory), for example, Random Access Memory (RAM) or other dynamic memory, for storing information and instructions to be executed by the processor 902. The memory 906 also may be used for storing temporary variables or other intermediate information during execution of instructions to be executed by the processor 902. The computing system 900 may likewise include a read only memory (“ROM”) or other static storage device coupled to bus 904 for storing static information and instructions for the processor 902.

The computing system 900 may also include a storage devices 908, which may include, for example, a media drive 910 and a removable storage interface. The media drive 910 may include a drive or other mechanism to support fixed or removable storage media, such as a hard disk drive, a floppy disk drive, a magnetic tape drive, an SD card port, a USB port, a micro USB, an optical disk drive, a CD or DVD drive (R or RW), or other removable or fixed media drive. A storage media 912 may include, for example, a hard disk, magnetic tape, flash drive, or other fixed or removable medium that is read by and written to by the media drive 910. As these examples illustrate, the storage media 912 may include a computer-readable storage medium having stored therein particular computer software or data.

In alternative embodiments, the storage devices 908 may include other similar instrumentalities for allowing computer programs or other instructions or data to be loaded into the computing system 900. Such instrumentalities may include, for example, a removable storage unit 914 and a storage unit interface 916, such as a program cartridge and cartridge interface, a removable memory (for example, a flash memory or other removable memory module) and memory slot, and other removable storage units and interfaces that allow software and data to be transferred from the removable storage unit 914 to the computing system 900.

The computing system 900 may also include a communications interface 918. The communications interface 918 may be used to allow software and data to be transferred between the computing system 900 and external devices. Examples of the communications interface 918 may include a network interface (such as an Ethernet or other NIC card), a communications port (such as for example, a USB port, a micro USB port), Near field Communication (NFC), etc. Software and data transferred via the communications interface 918 are in the form of signals which may be electronic, electromagnetic, optical, or other signals capable of being received by the communications interface 918. These signals are provided to the communications interface 918 via a channel 920. The channel 920 may carry signals and may be implemented using a wireless medium, wire or cable, fiber optics, or other communications medium. Some examples of the channel 920 may include a phone line, a cellular phone link, an RF link, a Bluetooth link, a network interface, a local or wide area network, and other communications channels.

The computing system 900 may further include Input/Output (I/O) devices 922. Examples may include, but are not limited to a display, keypad, microphone, audio speakers, vibrating motor, LED lights, etc. The I/O devices 922 may receive input from a user and also display an output of the computation performed by the processor 902. In this document, the terms “computer program product” and “computer-readable medium” may be used generally to refer to media such as, for example, the memory 906, the storage devices 908, the removable storage unit 914, or signal(s) on the channel 920. These and other forms of computer-readable media may be involved in providing one or more sequences of one or more instructions to the processor 902 for execution. Such instructions, generally referred to as “computer program code” (which may be grouped in the form of computer programs or other groupings), when executed, enable the computing system 900 to perform features or functions of embodiments of the present invention.

In an embodiment where the elements are implemented using software, the software may be stored in a computer-readable medium and loaded into the computing system 900 using, for example, the removable storage unit 914, the media drive 910 or the communications interface 918. The control logic (in this example, software instructions or computer program code), when executed by the processor 902, causes the processor 902 to perform the functions of the invention as described herein.

Various embodiments provide method and system for authentication of a user. The disclosed method and system may receive a unique session key for a session. Further, the disclosed method and system may generate an optical signal sequence based on the unique session key to obtain a depth-encoded capture of at least one facial region of a user. The depth-encoded capture may include the optical signal sequence projected upon the at least one facial region of the user. Further, the disclosed method and system may generate a depth-encoded facial vector corresponding to the user based on the depth-encoded capture. The depth-encoded facial vector may include a set of first facial features and a set of first optical signal sequence features. Thereafter, the disclosed method and system may transmit the depth-encoded facial vector corresponding to the user to one or more authentication devices. Each of the one or more authentication devices is configured to contemporaneously receive a surface capture of a video feed corresponding to the session from one of the user device or a second user device. Each of the one or more authentication devices is also configured to generate a surface facial vector corresponding to the user based on the surface capture of the video feed. The surface facial vector may include a set of second facial features and a set of second optical signal sequence features. Each of the one or more authentication devices is also configured to compare the depth-encoded facial vector with the surface facial vector based on a similarity analysis to self-authenticate the user.

Thus, the disclosed method and system try to overcome the technical problem of authentication of a user. The disclosed method and system may provide secure video conferencing for high-stakes meetings, remote depositions, telemedicine, or the like. The disclosed method and system may provide remote onboarding (or Know Your Customer (KYC)) to verify identity for financial services or employment without in-person checks. The disclosed method and system may provide one-to-one transactions by adding identity verification layer to one-to-one finance (or marketplaces). The disclosed method and system may provide physical site access by granting one time access to physical locations under remote surveillance. The disclosed method and system may enable verification of signatories remotely. The method and system may enable authentication of public figures during a live broadcast. The method and system may provide a liveness and binding mechanism for Self-Sovereign Identity (SSI) ecosystems. The method and system may reduce deepfakes, AI attacks, or the like.

In light of the above mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only.

What is claimed is:

1. A method for authentication of a user, the method comprising:
receiving, by a user device, a unique session key for a session;
generating, by the user device, an optical signal sequence based on the unique session key to obtain a depth-encoded capture of at least one facial region of a user, wherein the depth-encoded capture comprises the optical signal sequence projected upon the at least one facial region of the user;
generating, by the user device, a depth-encoded facial vector corresponding to the user based on the depth-encoded capture, wherein the depth-encoded facial vector comprises a set of first facial features and a set of first optical signal sequence features;
transmitting, by the user device, the depth-encoded facial vector corresponding to the user to one or more authentication devices;
wherein each of the one or more authentication devices is configured to:
contemporaneously receive a surface capture of a video feed corresponding to the session from one of the user device or a second user device;
generate a surface facial vector corresponding to the user based on the surface capture, wherein the surface facial vector comprises a set of second facial features; and
compare the depth-encoded facial vector with the surface facial vector based on a similarity analysis to authenticate the user.

2. The method of claim 1, wherein generating the depth-encoded facial vector comprises generating the depth-encoded facial vector using a Convolutional Neural Network (CNN) model.

3. The method of claim 2, further comprising:
extracting, by the user device, a set of geometrical features from the depth-encoded capture using the CNN model; and
evaluating, by the user device, a depth corresponding to the at least one facial region of the user based on the set of geometrical features.

4. The method of claim 2, wherein generating the depth-encoded facial vector comprises:
extracting, by the user device, the set of first facial features and the set of first optical signal sequence features from the depth-encoded capture using the CNN model; and
encoding, via the CNN model, the depth-encoded facial vector using the set of facial features and the set of optical signal sequence features, wherein the depth-encoded facial vector comprises an entanglement of the set of first facial features with the set of optical signal sequence features, and wherein the depth-encoded facial vector is transformed through a rotation operation based on the unique session key.

5. A method for authentication of a user, the method comprising:
receiving, by an authenticating device, a unique session key for a session;
receiving, by the authenticating device, a depth-encoded facial vector corresponding to a user from a user device, wherein the user device is configured to:
generate an optical signal sequence based on the unique session key to obtain a depth-encoded capture of at least one facial region of the user, wherein the depth-encoded capture comprises the optical signal sequence projected upon the at least one facial region of the user;
generate the depth-encoded facial vector corresponding to the user based on the depth-encoded capture, wherein the depth-encoded facial vector comprises a set of first facial features and a set of first optical signal sequence features; and
transmit the depth-encoded facial vector corresponding to the user to the authenticating device;
contemporaneously receiving, by the authenticating device, a surface capture of a video feed corresponding to the session from one of the user device or a second user device;
generating, by the authenticating device, a surface facial vector corresponding to the user based on the surface capture, wherein the surface facial vector comprises a set of second facial features and a set of second optical signal sequence features; and
comparing, by the authenticating device, the depth-encoded facial vector with the surface facial vector using a decoding technique.

6. The method of claim 5, wherein comparing the depth-encoded facial vector with the surface facial vector comprises:
comparing the set of first facial features with the set of second facial features based on the similarity analysis to obtain a facial feature similarity score; and
comparing the facial feature similarity score with a predefined threshold similarity score.

7. The method of claim 6, wherein comparing the depth-encoded facial vector with the surface facial vector comprises:
generating a first reconstructed session key representation from the set of first optical signal sequence features using the decoding technique;
generating a second reconstructed session key representation from the surface facial vector using the decoding technique;
computing a sequence fidelity score based on a comparison between the first reconstructed session key representation, the second reconstructed session key representation, and the unique session key; and
comparing the sequence fidelity score with a predefined threshold fidelity score.

8. The method of claim 7, wherein comparing the depth-encoded facial vector with the surface facial vector comprises authenticating the user based on the similarity score and the sequence fidelity score.

9. A system for authentication of a user, the system comprising:
a processor; and
a memory communicatively coupled to the processor, wherein the memory stores processor executable instructions, which, on execution, causes the processor to:
receive a unique session key for a session;
generate an optical signal sequence based on the unique session key to obtain a depth-encoded capture of at least one facial region of a user, wherein the depth-encode capture comprises the optical signal sequence projected upon the at least one facial region of the user;
generate a depth-encoded facial vector corresponding to the user based on the depth-encoded capture, wherein the depth-encoded facial vector comprises a set of first facial features and a set of first optical signal sequence features;
transmit the depth-encode facial vector corresponding to the user to one or more authentication devices;
wherein each of the one or more authentication devices is configured to:
contemporaneously receive a surface capture of a video feed corresponding to the session from one of the user device or a second user device;
generate a surface facial vector corresponding to the user based on the surface capture of the video feed, wherein the surface facial vector comprises a set of second facial features and a set of second optical signal sequence features; and
compare the depth-encode facial vector with the surface facial vector based on a similarity analysis to authenticate the user.

10. The system of claim 9, wherein to generate the depth-encoded facial vector, the processor executable instructions further cause the processor to generate the depth-encoded facial vector corresponding to the depth-encoded capture using a Convolutional Neural Network (CNN) model.

11. The system of claim 10, wherein the processor executable instructions further cause the processor to:
extract a set of geometrical features from the depth-encoded capture using the CNN model; and
evaluate a depth corresponding to the at least one facial region of the user based on the set of geometrical features.

12. The system of claim 11, wherein to generate the depth-encoded facial vector, the processor executable instructions cause the processor to:
extract the set of first facial features and the set of first optical signal sequence features from the depth-encoded capture using the CNN model; and
encode, via the CNN model, the depth encoded facial vector using the set of first facial features and the set of first optical signal sequence features, wherein the depth-encoded facial vector comprises an entanglement of the set of first facial features with the set of first optical signal sequence features, and wherein the depth-encoded facial vector is transformed through a rotation operation based on the unique session key.

13. A system for authentication of a user, the system comprising:
a processor; and
a memory communicatively coupled to the processor, wherein the memory stores processor executable instructions, which, on execution, causes the processor to:
receive a unique session key for a session;
receive a depth-encoded facial vector corresponding to a user from a user device, wherein the user device is configured to:
generate an optical signal sequence based on the unique session key to obtain a depth-encoded capture of at least one facial region of the user, wherein the depth-encoded capture comprises the optical signal sequence projected upon the at least one facial region of the user;
generate the depth-encode facial vector corresponding to the user based on the depth-encoded capture, wherein the depth-encoded facial vector comprises a set of first facial features and a set of first optical signal sequence features; and
transmit the depth0encoded facial vector corresponding to the user to the authenticating device;
contemporaneously receive a surface capture of a video feed corresponding to the session from one of the user device or a second user device;
generate a surface facial vector corresponding to the user based on the surface capture of the video feed, wherein the surface facial vector comprises a set of second facial features and a set of second optical signal sequence features; and
compare the depth-encoded facial vector with the surface facial vector using a decoding technique.

14. The system of claim 13, wherein to compare the depth-encoded facial vector with the surface facial vector, the processor executable instructions further cause the processor to:
compare the set of first facial features with the set of second facial features based on the similarity analysis to obtain a facial feature similarity score; and
compare the facial feature similarity score with a predefined threshold similarity score.

15. The system of claim 14, wherein to compare the depth-encoded facial vector with the surface facial vector, the processor executable instructions further cause the processor to:
generate a first reconstructed session key representation from the set of first optical signal sequence features using the decoding technique;
generate a second reconstructed session key representation from the surface facial vector using the decoding technique;
compute a sequence fidelity score based on a comparison between the first reconstructed session key representation, the second reconstructed session key representation, and the unique session key; and
compare the sequence fidelity score with a predefined threshold fidelity score.

16. The system of claim 15, wherein to compare the depth-encoded facial vector with the surface facial vector, the processor executable instructions further cause the processor to authenticate the user based on the similarity score and the sequence fidelity score.
